(19) United States
(12) Patent Application Publication
(10) Pub. No.: US 2015/0134492 A1
(43) Pub. Date: May 14, 2015

(54) COORDINATED IMAGE MANIPULATION

(71) Applicant: Apple Inc., Cupertino, CA (US)

(72) Inventors: Richard A. HARRISON, San Francisco, CA (US); Harrison LEE, San Francisco, CA (US); Ken T. LOH, San Jose, CA (US); Bobbykin MAKWANA, Sunnyvale, CA (US); Kirk VON ROHR, Atherton, CA (US)

(73) Assignee: Apple Inc., Cupertino, CA (US)

(21) Appl. No.: 14/077,077

(22) Filed: Nov. 11, 2013

(51) Int. Cl. G06F 3/0484; G06Q 30/06

(52) U.S. Cl. CPC G06F 3/04845; G06Q 30/0643
USPC 705/27.2; 715/760

(57) ABSTRACT

Coordinating the manipulation of multiple images in a user interface. An input for manipulating a first image can be received. The first image can be manipulated in accordance with the input. A second image, different from the first image, can also be manipulated in accordance with the input. In some examples, a content of the manipulated first image can correspond to a content of the manipulated second image. In some examples, whether the second image is manipulated can be determined based on various considerations including whether the first and second images are associated with the same category, whether the first and second images are associated with sets of images having the same number of images and/or whether a plurality of images including the first and second images are associated with the same category.

### FIELD OF THE DISCLOSURE

This relates generally to viewing images, and more particularly to manipulating them in a coordinated manner.

### BACKGROUND OF THE DISCLOSURE

Many electronic devices with displays present user interfaces that display multiple images concurrently, such as for electronic or online storefronts. Sometimes, the presentation of one of the images can be manipulated so as to display a different angle of a product in the store, for example. However, comparing many products from that same angle may require manually manipulating the presentations of the other images.

### SUMMARY OF THE DISCLOSURE

Various examples are related to methods of coordinating the manipulation of multiple images in a user interface. In some examples, the user interface can be a user interface for an electronic storefront that presents multiple images of multiple products that may be available for purchase. An input for manipulating a first of the images of the products can be received to, for example, present a different view of a particular product (e.g., a side view). In some examples, the input can be a touch input, such as a gesture, or a keyboard input. The image can be manipulated in accordance with the input to, for example, present the side view of the product. Another image of another product can also be manipulated in accordance with the input to, for example, also present a side view of the other product. In this way, an input for manipulating one image of a product can result in more than one image of other product(s) being manipulated in a coordinated manner, facilitating a user's experience navigating through the storefront and comparing products with each other at corresponding relevant angles.

### BRIEF DESCRIPTION OF THE DRAWINGS

FIG. 1A illustrates an exemplary user interface for displaying a plurality of images according to examples of the disclosure.

FIG. 1B illustrates a manipulation of an image according to examples of the disclosure.

FIG. 1C illustrates a coordinated manipulation of some images in accordance with a manipulation of another image, according to examples of the disclosure.

FIG. 2A illustrates a dedicated user interface displaying an element containing an image, according to examples of the disclosure.

FIG. 2B illustrates manipulation of an image in an element in a dedicated user interface, according to examples of the disclosure.

FIG. 2C illustrates coordinated manipulation of a different image in a different element in a dedicated user interface, according to examples of the disclosure

FIG. 3 illustrates an exemplary method of coordinating the manipulation of images, according to examples of the disclosure.

FIG. 4 is a block diagram illustrating an exemplary API architecture, which may be used in some examples of the disclosure.

FIG. 5 illustrates an exemplary software stack of an API according to examples of the disclosure.

FIG. 6 is a block diagram illustrating exemplary interactions between the touch screen and other components of the device according to examples of the disclosure.

FIG. 7 is a block diagram illustrating an example of a system architecture that may be embodied within any portable or non-portable device according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

Various examples are related to methods of coordinating the manipulation of multiple images in a user interface. In some examples, the user interface can be a user interface for an electronic storefront that presents multiple images of multiple products that may be available for purchase. An input for manipulating a first of the images of the products can be received to, for example, present a different view of a particular product (e.g., a side view). In some examples, the input can be a touch input, such as a gesture, or a keyboard input. The image can be manipulated in accordance with the input to, for example, present the side view of the product. Another image of another product can also be manipulated in accordance with the input to, for example, also present a side view of the other product. In this way, an input for manipulating one image of a product can result in more than one image of other product(s) being manipulated in a coordinated manner, facilitating a user's experience navigating through the storefront and comparing products with each other at corresponding relevant angles.

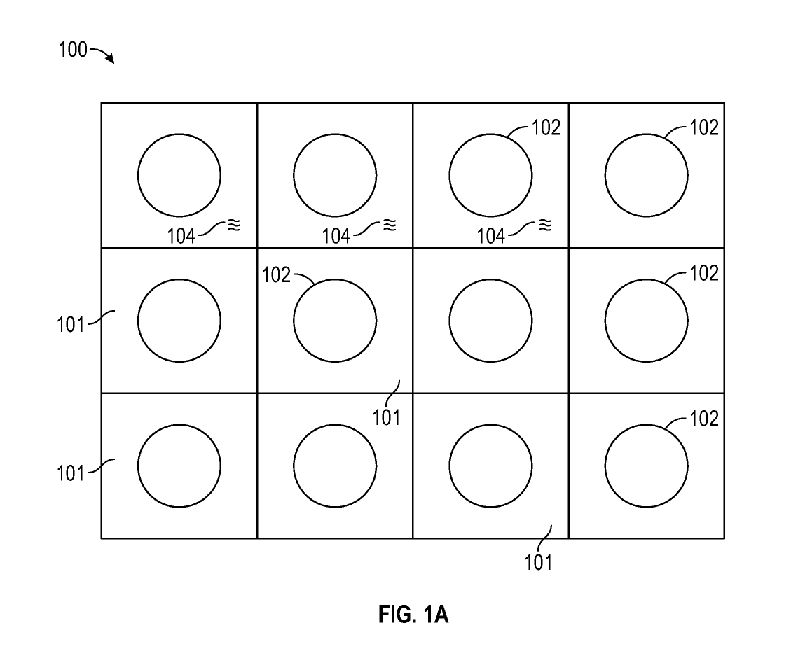

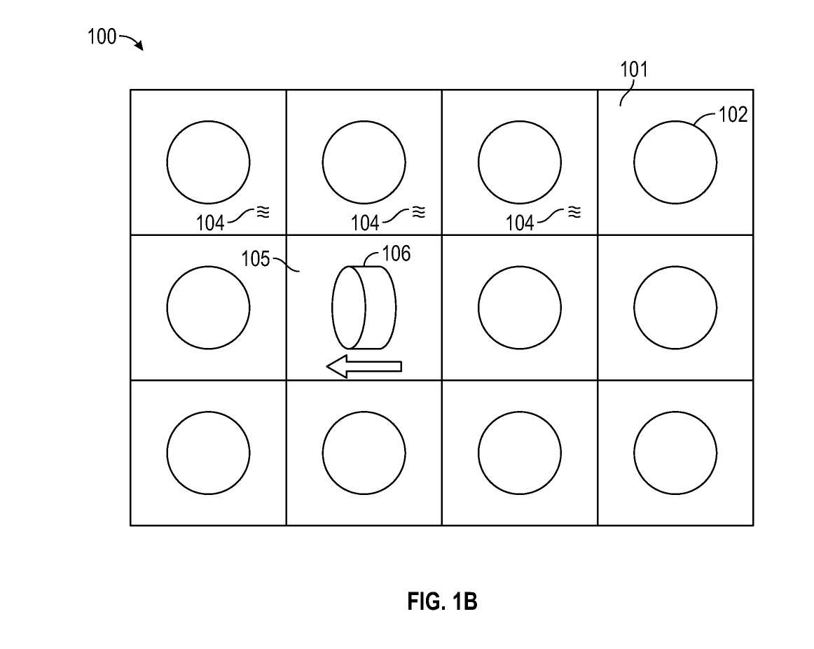

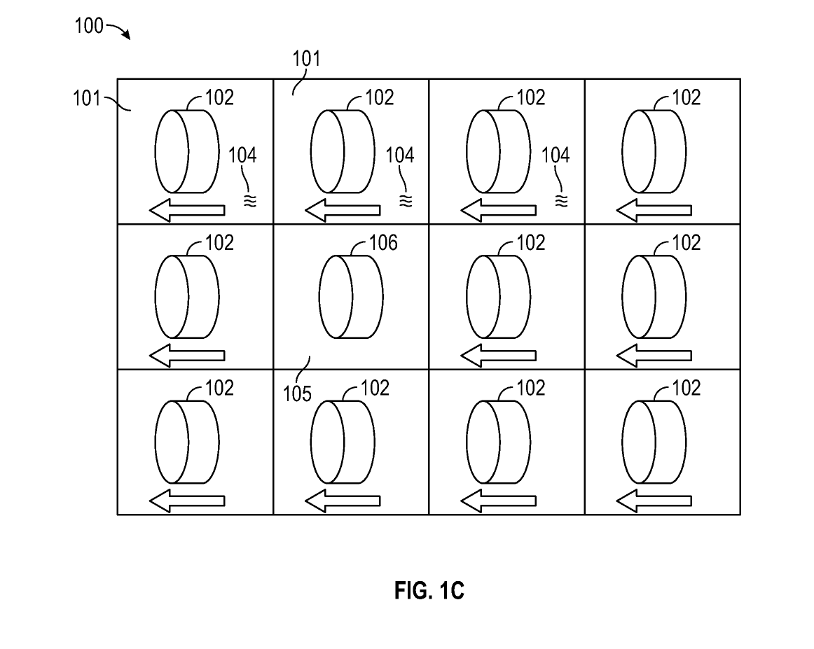

FIGS. 1A-1C show exemplary operation of the coordinated image manipulation of the disclosure. FIG. 1A illustrates an exemplary user interface 100 for displaying a plurality of images 102 according to examples of the disclosure. User interface 100 can include a plurality of elements 101, each element displaying an image 102. In the illustrated example, user interface 100 can include twelve elements 101, and therefore twelve images 102 can be displayed, though more or less elements and/or images can also be displayed. Though the images 102 of this disclosure will be described as being contained in or associated with elements 101, it is understood that the scope of this disclosure is not limited to images that are contained in elements or in any other data structures.

Images 102 can be substantially similar in size, though they need not be. Images 102 can be displayed concurrently, as illustrated, and can be displayed in a grid, though this need not be the case. In some examples, user interface 100 can be a user interface presented by an electronic or online storefront, elements 101 can correspond to a variety of products in the store (e.g., bags and/or shoes), and images 102 can be images of the variety of products. In some examples, elements 101, and therefore images 102, can correspond to and be of different types of products; in some examples, the elements and the images can correspond to and be of the same type of product. For example, elements 101 can all be elements corresponding to shoes, and therefore images 102 can also be images of shoes. In some examples, some of elements 101 can correspond to shoes, some of the elements can correspond to bags, and some of the elements can correspond to electronic cables. In such a circumstance, images 102 can be a mix of images of shoes, bags and electronic cables. In some examples, images 102 can provide views that can be substantially similar to one another. For example, images 102 can present views of a variety of shoes from similar angles and distances with respect to the shoes. Though examples of this disclosure are described with reference to products and storefronts, the scope of this disclosure is not so limited, and extends to any context in which multiple images may be displayed concurrently in a user interface.

In some examples, elements 101 can include information 104 as well as images 102. Information 104 can be any information that may be associated with the product to which element 101 and image 102 can correspond. For example, if element 101 is associated with a product, such as a shoe, information 104 can be price information, description information, availability information, and/or other related information for the shoe.

In some examples, elements 101 can be associated with images that may not be currently visible in user interface 100 (i.e., images other than images 102). These currently invisible images can be made visible in response to a specified input (this will be described in more detail below). For example, if each element 101 is associated with a shoe, each of the elements can be associated with multiple images of each shoe, respectively, one or more of those images being currently visible as images 102. In some examples, the images, both those that are visible and not visible, can provide views of each respective shoe from different angles, for example.

FIG. 1B illustrates a manipulation of image 106 according to examples of the disclosure. Elements 101 and images 102 can be those of FIG. 1A, except that image 106 can be manipulated, as illustrated. For example, image 106 can be manipulated to present a side view of a product with which element 105 can be associated. It is noted that manipulation of an image, as used in this disclosure, does not require that the image being manipulated actually be changed in any way. Rather, manipulation of an image can be a modification of what is displayed at the location of the image. For example, manipulation of an image can include scrolling from one image associated with element 105 to another image associated with the element so that a side view of a shoe, for example, can be changed to a bottom view of the shoe (i.e., a user can scroll from an image presenting a side view of the shoe to an image presenting a bottom view of the shoe). Manipulation of an image can also include zooming into an image, rotating a 3D model of a product (and thus changing a display of the product), adding text to, or adjacent to, an image (e.g., price information overlaid on an image of a product), applying a filter to an image, displaying an image showing a product in a different color, and any other action that can change what is being visually presented at the location of the image in the user interface. Further, the image need not be a static image, but can be any object that can present a visual depiction on a display (e.g., a video, a 3D model, etc.).

Image 106 can be manipulated, as described above, by an appropriate input, such as a horizontal sliding gesture to scroll from an image of a front view of a product to an image of a side view of the product, for example. Many other inputs for manipulating image 106 are also within the scope of this disclosure, such as other touch inputs, selection of one or more input buttons on user interface 100, and depression of one or more keys on a keyboard, for example.

In some examples, in response to the manipulation of image 106, and despite the lack of an explicit input to do so, other images 102 can be manipulated in a manner coordinated with the manipulation of image 106. FIG. 1C illustrates a coordinated manipulation of images 102 in accordance with a manipulation of image 106, according to examples of the disclosure. If image 106 has been manipulated to present a side view of a product, for example, images 102 can be manipulated to similarly present side views of their respective products, even though no input or designation may have been provided to do so. As another example, if image 106 has been manipulated to present price information for a product associated with element 105 (e.g., the price information overlays image 106 or replaces image 106), remaining images 102 can also be similarly manipulated to present price information for products associated with elements 101, respectively. In some examples, any other manipulation of image 106 (e.g., zooming, filtering, etc.) can similarly result in a corresponding manipulation of remaining images 102. In this way, a manipulation of a single image, for example image 106, can result in a corresponding manipulation of one or more other images, such as images 102, facilitating a user's browsing and comparing of multiple products and/or images at the same time. Therefore, a user need not input or otherwise identify the images to be manipulated by the user's input (e.g., a user need not select multiple images for manipulation), but rather, in the examples of this disclosure, the user can simply specify a single image for manipulation, and other images can be manipulated accordingly.

In some examples, manipulation of other images 102 can occur a time period after manipulation of image 106. For example, manipulation of other images 102 can occur one second after manipulation of image 106.

In some examples, whether other images 102 are to be manipulated in accordance with a manipulation of image 106 can be based on respective categorizations of element 105 (containing image 106) and elements 101 (containing images 102). For example, element 105 can be associated with a product of a specific type or category, for example, a shoe. In some examples, if image 106 is manipulated to, for example, display a different view of the shoe, only those of images 102 that are also associated with shoes can be manipulated in a manner coordinated with the manipulation of image 106. Any images 102 associated with products of a different category or type (i.e., other than shoes) can remain non-manipulated.

In some examples, the coordinated image manipulation of this disclosure will only occur if all of the elements 101 and 105 displayed in user interface 100 are associated with, and display images of, products of the same type. For example, user interface 100 can display twelve elements 101 and 105 as results of a search request in an online store. The search result can sometimes include more than twelve elements, which cannot be currently displayed in user interface 100 because of lack of space, but which can be accessed by collectively scrolling through the collection of search result elements. In some examples, if the currently displayed twelve elements 101 and 105, for example, are all of the same type (i.e., are all associated with shoes, for example), coordinated image manipulation can be performed on images 102 and 106, irrespective of the types of elements that may be part of the search results that are currently not displayed in user interface 100. If, however, the displayed elements 101 and 105 are scrolled such that elements of more than a single category or type are currently displayed in user interface 100, in some examples, coordinated image manipulation can be disabled. In some examples, all elements of the search result, whether or not currently displayed in user interface 100, must be of the same type for the coordinated image manipulation of this disclosure to be performed.

In some examples, the coordinated image manipulation of this disclosure is only performed when a collection of elements is navigated to by way of category navigation in an online store, for example, and not by way of a search query. For example, an online store can allow for browsing of products by category (e.g., shoes, bags, electronic cables, etc.) and searching for products by search query. In some examples, coordinated image manipulation can be allowed in the former but not the latter circumstance because whether results from a search query will display elements and products of the same type or category can sometimes be unpredictable. In some examples, however, a search query can be sufficiently similar to an existing category of products that the corresponding search results can be that of the category searched (i.e., the search logic can place a user in the category searched instead of displaying the results as results of a search query). In such an instance, the coordinated image manipulation of this disclosure can be performed on the search results, as long as the category searched is one that has been designated as allowing such coordinated image manipulation (this will be described in more detail later). In some examples, the elements of a specific category can be filtered by a specific characteristic (e.g., color), and the filtered set of products in the category can continue to allow for the coordinated image manipulation of this disclosure.

In some examples, despite all of elements 101 and 105 being of a specific type or category (e.g., audio equipment), products of that type can have sufficiently different form factors that the coordinated image manipulation of the disclosure may be unsuitable for the products of that type. For example, audio equipment as a category can include products such as headphones, speakers and musical instruments. These products can have divergent form factors such that coordinating the display of side views of these products (e.g., headphones and a guitar) may not provide a useful comparison to a user. Therefore, in some examples, one or more types or categories of products may be designated as not allowing coordinated image manipulation. While some categories may not allow for coordinated image manipulation, in some examples, one or more subcategories of those categories can allow for coordinated image manipulation. For example, while the audio equipment category may not allow for coordinated image manipulation, a sub-category of over-ear headphones may, because products and images in that sub-category may be sufficiently similar to each other to provide meaningful comparison of different products using coordinated views.

In some examples, images associated with each element 101 and 105 being displayed in user interface 100 can be normalized such that each element associated with a product type can have associated with it the same number of images as other elements associated with that product type, and those images can present the same views of the products with which the elements and the images are associated. For example, elements associated with shoes can all include four views of each shoe, including a bottom view, a top view, and two side views. The ordering and display of the images can also be coordinated such that manipulating an image in one element to display a side view of a shoe, for example, can result in a corresponding display of a side view of another shoe associated with another element. The number of images associated with each element can be category or type-specific, and can depend on how many and which views of a product can be useful for a user to view when viewing information about the product. In some examples, coordinated image manipulation will only be allowed if the elements and the products for which coordinated image manipulation is to be performed are associated with the correct number of images and/or the correct views of the product, as described above.

In some examples, an element associated with a product will only be displayed in user interface 100 if that element has associated with it the requisite number of images and views designated for the product's category. For example, an element associated with a new product may not have all the designated images and/or views for that product. In some examples, this product can be displayed in search results so that the product can be found and purchased by a user; however, the product may sometimes be hidden when a user navigates to a category including the product such that the product's lack of the requisite images and/or views will not disrupt the coordinated image manipulation of the rest of the products of that category.

In some examples, images associated with each element 101 and 105 can provide views of a product from different angles. In some examples, the images can be views of different focus areas of a product. For example, when viewing images of computer cables, one set of images can provide views of the connectors/ends of the cables, and another set of images can provide views of the remaining portions of the cables. As such, it is understood that the images of this disclosure can provide any view(s) that may be helpful to a user when browsing, viewing, purchasing, learning about and/or comparing products.

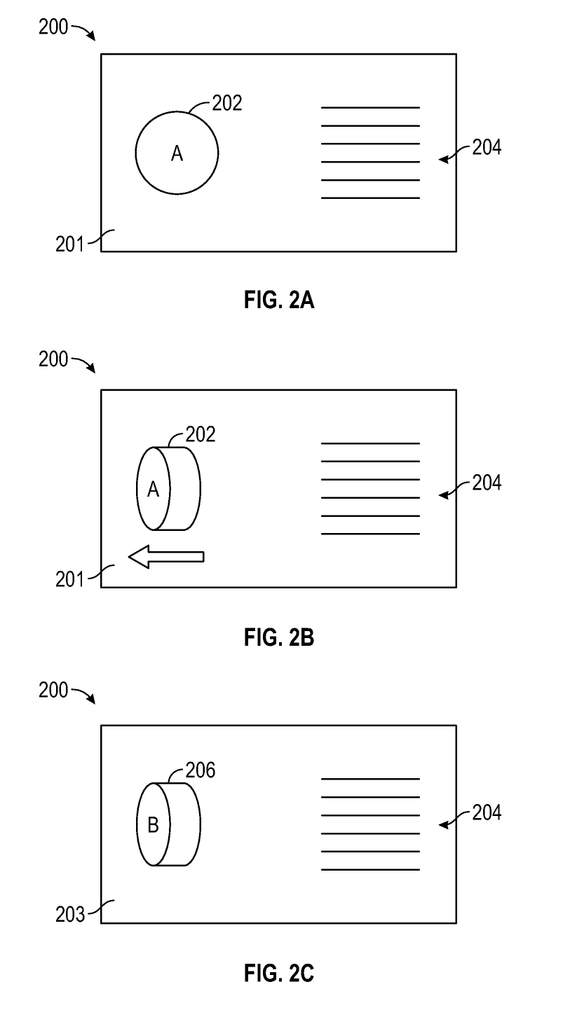

The coordinated image manipulation of the disclosure is not limited to coordinating the manipulation of images currently visible on a user interface, but can also be applied to images that are not currently displayed in the user interface. FIGS. 2A-2C illustrate the coordinated image manipulation of this disclosure as applied to images that are not currently visible or displayed on a user interface. FIG. 2A illustrates dedicated user interface 200 displaying element 201 containing image 202, according to examples of the disclosure. Similar to what has been previously described, element 201 can include image 202 and information 204. Element 201, and therefore image 202 and information 204, can be associated with a product. In some examples, user interface 200 can be a user interface resulting from a selection or a zooming in of an element 101 or 105 or image 102 or 106 from user interface 100. In other words, user interface 200 can provide a dedicated view of element 101 or 105. Image 202 that can be displayed in user interface 200 after a selection or zooming in of image 102 or 106 can be the same image as image 102 or 106 (i.e., the same view as presented in image 102 or 106). Selection or zooming in of image 102 or 106 can be accomplished with an appropriate input, such as selection of a user interface input element (e.g., a button), a gesture (e.g., pinch-in gesture using two fingers) or any other input.

Multiple elements and associated products can be browsed in the dedicated user interface 200 of FIGS. 2A-2C. For example, a user can utilize a vertical swiping gesture, for example, to move from one product to another. Other inputs can alternatively or additionally be used as well. In response to one or more of the above inputs, user interface 200 can transition to display different elements and products. For example, user interface 200 can sequentially provide dedicated display of elements of a search result or of a category of products.

FIG. 2B illustrates manipulation of image 202 in element 201 in dedicated user interface 200, according to examples of the disclosure. Image 202 in element 201 can be manipulated as described above with reference to FIGS. 1A-1C. In the illustrated example, image 202 can be manipulated to present a side view of a product, for example. However, as stated above, image 202 need not be manipulated in this way, and it is understood that image 202 can be manipulated in other ways.

FIG. 2C illustrates coordinated manipulation of image 206 in element 203 in a dedicated user interface 200, according to examples of the disclosure. In response to the manipulation of image 202 in element 201, image 206 in element 203 can be manipulated in a coordinated manner, even though element 203 and image 206 may not be visible in user interface 200 at the time of the manipulation of image 202 in element 201. As a result, a user can navigate from element 201 containing image 202 to element 203 containing image 206 in user interface 200, and image 206 can be manipulated in a manner coordinated with the manipulation of image 202. In this way, a user can navigate through multiple elements and products, the associated images of which have been manipulated in a coordinated manner to facilitate product navigation and comparison. Details of coordinated image manipulation as described above with reference to FIGS. 1A-1C can similarly be applied in the context of FIGS. 2A-2C, where appropriate.

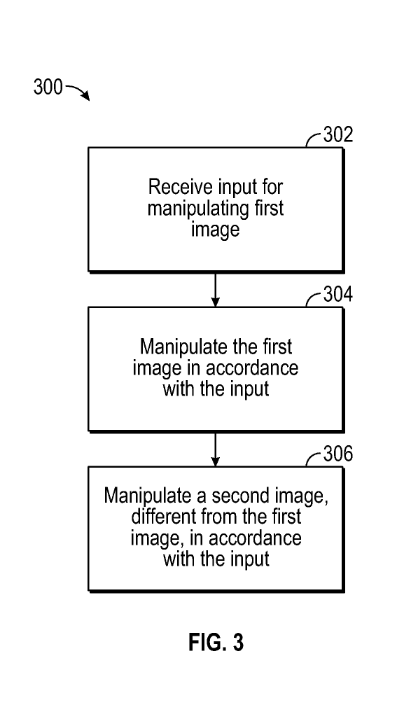

FIG. 3 illustrates exemplary method 300 of coordinating the manipulation of images, according to examples of the disclosure. At step 302, an input for manipulating a first image in a user interface can be received. The first image can present a first view of a first product, and the user interface can be a user interface for an electronic store, for example.

At step 304, the first image can be manipulated in accordance with the input. In some examples, the input can be a touch input. In some examples, the manipulation can be a replacement of the first image with an image presenting a second view of the first product, for example.

At step 306, a second image, different from the first image, can also be manipulated in accordance with the input. In some examples, the second image can present a first view of a second product, and the manipulation of the second image can be a replacement of the second image with an image presenting a second view of the second product.

The examples discussed above can be implemented in one or more Application Programming Interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component.

The above-described features can be implemented as part of an application program interface (API) that can allow it to be incorporated into different applications (e.g., spreadsheet apps) utilizing touch input as an input mechanism, for example. An API can allow a developer of an API-calling component (which may be a third party developer) to leverage specified features, such as those described above, provided by an API-implementing component. There may be one API-calling component or there may be more than one such component. An API can be a source code interface that a computer system or program library provides in order to support requests for services from an application. An operating system (OS) can have multiple APIs to allow applications running on the OS to call one or more of those APIs, and a service (such as a program library) can have multiple APIs to allow an application that uses the service to call one or more of those APIs. An API can be specified in terms of a programming language that can be interpreted or compiled when an application is built.

In some examples, the API-implementing component may provide more than one API, each providing a different view of the functionality implemented by the API-implementing component, or with different aspects that access different aspects of the functionality implemented by the API-implementing component. For example, one API of an API-implementing component can provide a first set of functions and can be exposed to third party developers, and another API of the API-implementing component can be hidden (not exposed) and provide a subset of the first set of functions and also provide another set of functions, such as testing or debugging functions which are not in the first set of functions. In other examples the API-implementing component may itself call one or more other components via an underlying API and thus be both an API-calling component and an API-implementing component.

An API defines the language and parameters that API-calling components use when accessing and using specified features of the API-implementing component. For example, an API-calling component accesses the specified features of the API-implementing component through one or more API calls or invocations (embodied, for example, by function or method calls) exposed by the API, and passes data and control information using parameters via the API calls or invocations. The API-implementing component may return a value through the API in response to an API call from an API-calling component. While the API defines the syntax and result of an API call (e.g., how to invoke the API call and what the API call does), the API may not reveal how the API call accomplishes the function specified by the API call. Various API calls are transferred via the one or more application programming interfaces between the calling (API-calling component) and an API-implementing component. Transferring the API calls may include issuing, initiating, invoking, calling, receiving, returning, or responding to the function calls or messages; in other words, transferring can describe actions by either of the API-calling component or the API-implementing component. The function calls or other invocations of the API may send or receive one or more parameters through a parameter list or other structure. A parameter can be a constant, key, data structure, object, object class, variable, data type, pointer, array, list or a pointer to a function or method or another way to reference a data or other item to be passed via the API.

Furthermore, data types or classes may be provided by the API and implemented by the API-implementing component. Thus, the API-calling component may declare variables, use pointers to, use or instantiate constant values of such types or classes by using definitions provided in the API.

Generally, an API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic. In some examples, an API may allow a client program to use the services provided by a Software Development Kit (SDK) library. In other examples, an application or other client program may use an API provided by an Application Framework. In these examples, the application or client program may incorporate calls to functions or methods provided by the SDK and provided by the API, or use data types or objects defined in the SDK and provided by the API. An Application Framework may, in these examples, provide a main event loop for a program that responds to various events defined by the Framework. The API allows the application to specify the events, and the responses to the events, using the Application Framework. In some implementations, an API call can report to an application the capabilities or state of a hardware device, including those related to aspects such as input capabilities and state, output capabilities and state, processing capability, power state, storage capacity and state, communications capability, etc., and the API may be implemented in part by firmware, microcode, or other low level logic that executes in part on the hardware component.

The API-calling component may be a local component (i.e., on the same data processing system as the API-implementing component) or a remote component (i.e., on a different data processing system from the API-implementing component) that communicates with the API-implementing component through the API over a network. It should be understood that an API-implementing component may also act as an API-calling component (i.e., it may make API calls to an API exposed by a different API-implementing component) and an API-calling component may also act as an API-implementing component by implementing an API that is exposed to a different API-calling component.

The API may allow multiple API-calling components written in different programming languages to communicate with the API-implementing component (thus the API may include features for translating calls and returns between the API-implementing component and the API-calling component); however, the API may be implemented in terms of a specific programming language. An API-calling component can, in one example, call APIs from different providers such as a set of APIs from an OS provider and another set of APIs from a plug-in provider and another set of APIs from another provider (e.g., the provider of a software library) or creator of the another set of APIs.

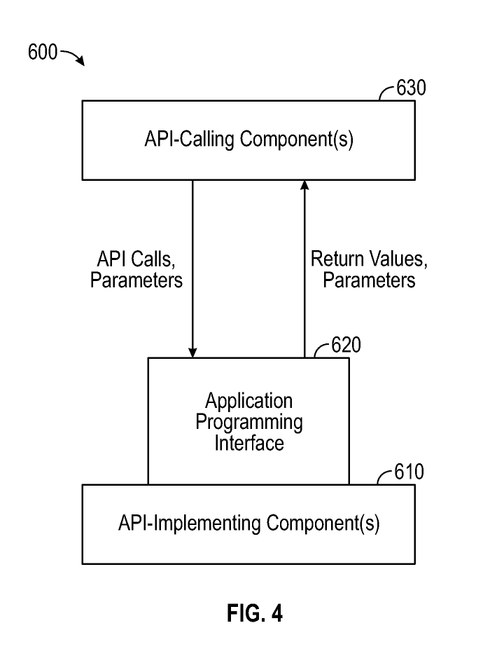

FIG. 4 is a block diagram illustrating an exemplary API architecture, which may be used in some examples of the disclosure. As shown in FIG. 4, the API architecture 600 includes the API-implementing component 610 (e.g., an operating system, a library, a device driver, an API, an application program, software or other module) that implements the API 620. The API 620 specifies one or more functions, methods, classes, objects, protocols, data structures, formats and/or other features of the API-implementing component that may be used by the API-calling component 630. The API 620 can specify at least one calling convention that specifies how a function in the API-implementing component receives parameters from the API-calling component and how the function returns a result to the API-calling component. The API-calling component 630 (e.g., an operating system, a library, a device driver, an API, an application program, software or other module), makes API calls through the API 620 to access and use the features of the API-implementing component 610 that are specified by the API 620. The API-implementing component 610 may return a value through the API 620 to the API-calling component 630 in response to an API call.

It will be appreciated that the API-implementing component 610 may include additional functions, methods, classes, data structures, and/or other features that are not specified through the API 620 and are not available to the API-calling component 630. It should be understood that the API-calling component 630 may be on the same system as the API-implementing component 610 or may be located remotely and access the API-implementing component 610 using the API 620 over a network. While FIG. 4 illustrates a single API-calling component 630 interacting with the API 620, it should be understood that other API-calling components, which may be written in different languages (or the same language) than the API-calling component 630, may use the API 620.

The API-implementing component 610, the API 620, and the API-calling component 630 may be stored in a non-transitory machine-readable storage medium, which includes any mechanism for storing information in a form readable by a machine (e.g., a computer or other data processing system). For example, a machine-readable medium includes magnetic disks, optical disks, random access memory; read only memory, flash memory devices, etc.

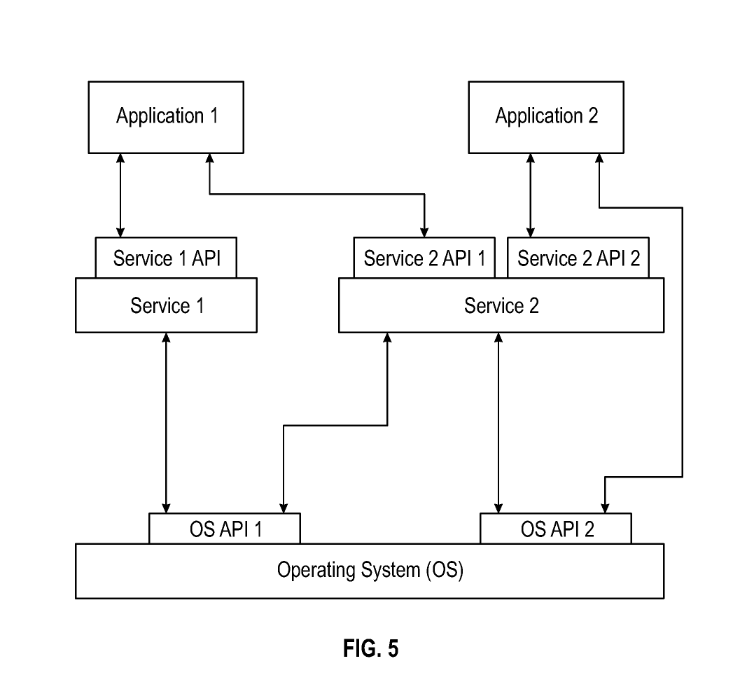

In the exemplary software stack shown in FIG. 5, applications can make calls to Services 1 or 2 using several Service APIs and to Operating System (OS) using several OS APIs. Services 1 and 2 can make calls to OS using several OS APIs. Note that Service 2 has two APIs, one of which (Service 2 API 1) receives calls from and returns values to Application 1 and the other (Service 2 API 2) receives calls from and returns values to Application 2. Service 1 (which can be, for example, a software library) makes calls to and receives returned values from OS API 1, and Service 2 (which can be, for example, a software library) makes calls to and receives returned values from both OS API 1 and OS API 2. Application 2 makes calls to and receives returned values from OS API 2.

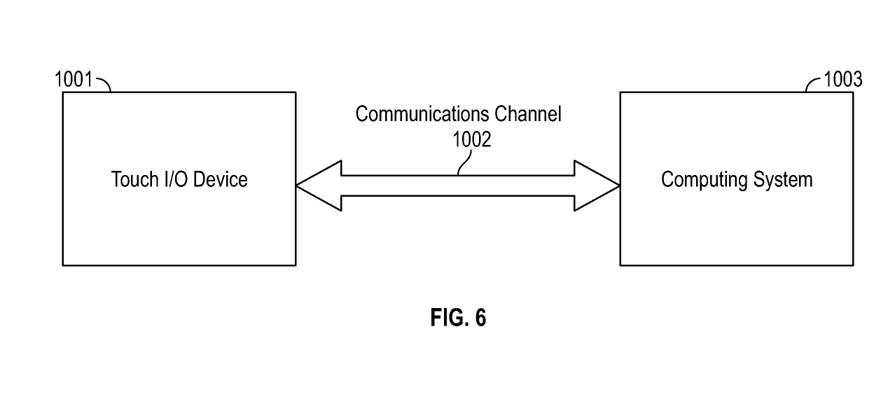

FIG. 6 is a block diagram illustrating exemplary interactions between the touch screen and the other components of the device. Described examples may include touch I/O device 1001 that can receive touch input for interacting with computing system 1003 via wired or wireless communication channel 1002. Touch I/O device 1001 may be used to provide user input to computing system 1003 in lieu of or in combination with other input devices such as a keyboard, mouse, etc. One or more touch I/O devices 1001 may be used for providing user input to computing system 1003. Touch I/O device 1001 may be an integral part of computing system 1003 (e.g., touch screen on a smartphone or a tablet PC) or may be separate from computing system 1003.

Touch I/O device 1001 may include a touch sensing panel, which is wholly or partially transparent, semitransparent, non-transparent, opaque or any combination thereof. Touch I/O device 1001 may be embodied as a touch screen, touch pad, a touch screen functioning as a touch pad (e.g., a touch screen replacing the touchpad of a laptop), a touch screen or touchpad combined or incorporated with any other input device (e.g., a touch screen or touchpad disposed on a keyboard) or any multi-dimensional object having a touch sensing surface for receiving touch input.

In one example, touch I/O device 1001 embodied as a touch screen may include a transparent and/or semitransparent touch sensing panel partially or wholly positioned over at least a portion of a display. According to this example, touch I/O device 1001 functions to display graphical data transmitted from computing system 1003 (and/or another source) and also functions to receive user input. In other examples, touch I/O device 1001 may be embodied as an integrated touch screen where touch sensing components/devices are integral with display components/devices. In still other examples a touch screen may be used as a supplemental or additional display screen for displaying supplemental or the same graphical data as a primary display and to receive touch input.

Touch I/O device 1001 may be configured to detect the location of one or more touches or near touches on device 1001 based on capacitive, resistive, optical, acoustic, inductive, mechanical, chemical measurements, or any phenomena that can be measured with respect to the occurrences of the one or more touches or near touches in proximity to device 1001. Software, hardware, firmware or any combination thereof may be used to process the measurements of the detected touches to identify and track one or more gestures. A gesture may correspond to stationary or non-stationary, single or multiple, touches or near touches on touch I/O device 1001. A gesture may be performed by moving one or more fingers or other objects in a particular manner on touch I/O device 1001 such as tapping, pressing, rocking, scrubbing, twisting, changing orientation, pressing with varying pressure and the like at essentially the same time, contiguously, or consecutively. A gesture may be characterized by, but is not limited to a pinching, sliding, swiping, rotating, flexing, dragging, or tapping motion between or with any other finger or fingers. A single gesture may be performed with one or more hands, by one or more users, or any combination thereof.

Computing system 1003 may drive a display with graphical data to display a graphical user interface (GUI). The GUI may be configured to receive touch input via touch I/O device 1001. Embodied as a touch screen, touch I/O device 1001 may display the GUI. Alternatively, the GUI may be displayed on a display separate from touch I/O device 1001. The GUI may include graphical elements displayed at particular locations within the interface. Graphical elements may include but are not limited to a variety of displayed virtual input devices including virtual scroll wheels, a virtual keyboard, virtual knobs, virtual buttons, any virtual UI, and the like. A user may perform gestures at one or more particular locations on touch I/O device 1001, which may be associated with the graphical elements of the GUI. In other examples, the user may perform gestures at one or more locations that are independent of the locations of graphical elements of the GUI. Gestures performed on touch I/O device 1001 may directly or indirectly manipulate, control, modify, move, actuate, initiate or generally affect graphical elements such as cursors, icons, media files, lists, text, all or portions of images, or the like within the GUI. For instance, in the case of a touch screen, a user may directly interact with a graphical element by performing a gesture over the graphical element on the touch screen. Alternatively, a touch pad generally provides indirect interaction. Gestures may also affect non-displayed GUI elements (e.g., causing user interfaces to appear) or may affect other actions within computing system 1003 (e.g., affect a state or mode of a GUI, application, or operating system). Gestures may or may not be performed on touch I/O device 1001 in conjunction with a displayed cursor. For instance, in the case in which gestures are performed on a touchpad, a cursor (or pointer) may be displayed on a display screen or touch screen and the cursor may be controlled via touch input on the touchpad to interact with graphical objects on the display screen. In other examples in which gestures are performed directly on a touch screen, a user may interact directly with objects on the touch screen, with or without a cursor or pointer being displayed on the touch screen.

Feedback may be provided to the user via communication channel 1002 in response to or based on the touch or near touches on touch I/O device 1001. Feedback may be transmitted optically, mechanically, electrically, olfactorily, acoustically, or the like or any combination thereof and in a variable or non-variable manner.

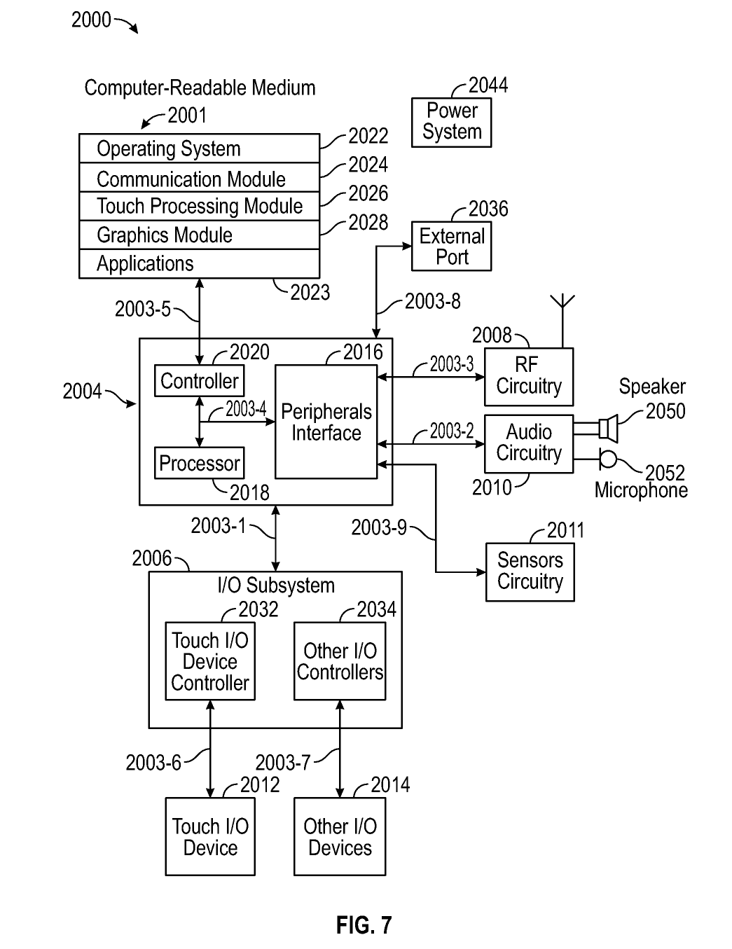

Attention is now directed towards examples of a system architecture that may be embodied within any portable or non-portable device including but not limited to a communication device (e.g., mobile phone, smart phone), a multi-media device (e.g., MP3 player, TV, radio), a portable or handheld computer (e.g., tablet, netbook, laptop), a desktop computer, an All-In-One desktop, a peripheral device, or any other system or device adaptable to the inclusion of system architecture 2000, including combinations of two or more of these types of devices. FIG. 7 is a block diagram of one example of system 2000 that generally includes one or more computer-readable mediums 2001, processing system 2004, I/O subsystem 2006, radio frequency (RF) circuitry 2008, audio circuitry 2010, and sensors circuitry 2011. These components may be coupled by one or more communication buses or signal lines 2003.

It should be apparent that the architecture shown in FIG. 7 is only one example architecture of system 2000, and that system 2000 could have more or fewer components than shown, or a different configuration of components. The various components shown in FIG. 7 can be implemented in hardware, software, firmware or any combination thereof, including one or more signal processing and/or application specific integrated circuits.

RF circuitry 2008 can be used to send and receive information over a wireless link or network to one or more other devices and includes well-known circuitry for performing this function. RF circuitry 2008 and audio circuitry 2010 can be coupled to processing system 2004 via peripherals interface 2016. Interface 2016 can include various known components for establishing and maintaining communication between peripherals and processing system 2004. Audio circuitry 2010 can be coupled to audio speaker 2050 and microphone 2052 and can include known circuitry for processing voice signals received from interface 2016 to enable a user to communicate in real-time with other users. In some examples, audio circuitry 2010 can include a headphone jack (not shown). Sensors circuitry 2011 can be coupled to various sensors including, but not limited to, one or more Light Emitting Diodes (LEDs) or other light emitters, one or more photodiodes or other light sensors, one or more photothermal sensors, a magnetometer, an accelerometer, a gyroscope, a barometer, a compass, a proximity sensor, a camera, an ambient light sensor, a thermometer, a GPS sensor, and various system sensors which can sense remaining battery life, power consumption, processor speed, CPU load, and the like.

Peripherals interface 2016 can couple the input and output peripherals of the system to processor 2018 and computer-readable medium 2001. One or more processors 2018 communicate with one or more computer-readable mediums 2001 via controller 2020. Computer-readable medium 2001 can be any device or medium that can store code and/or data for use by one or more processors 2018. In some examples, medium 2001 can be a non-transitory computer-readable storage medium. Medium 2001 can include a memory hierarchy, including but not limited to cache, main memory and secondary memory. The memory hierarchy can be implemented using any combination of RAM (e.g., SRAM, DRAM, DDRAM), ROM, FLASH, magnetic and/or optical storage devices, such as disk drives, magnetic tape, CDs (compact disks) and DVDs (digital video discs). Medium 2001 may also include a transmission medium for carrying information-bearing signals indicative of computer instructions or data (with or without a carrier wave upon which the signals are modulated). For example, the transmission medium may include a communications network, including but not limited to the Internet (also referred to as the World Wide Web), intranet(s), Local Area Networks (LANs), Wide Local Area Networks (WLANs), Storage Area Networks (SANs), Metropolitan Area Networks (MAN) and the like.

One or more processors 2018 can run various software components stored in medium 2001 to perform various functions for system 2000. In some examples, the software components can include operating system 2022, communication module (or set of instructions) 2024, touch processing module (or set of instructions) 2026, graphics module (or set of instructions) 2028, and one or more applications (or set of instructions) 2030. Each of these modules and above noted applications can correspond to a set of instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise rearranged in various examples. In some examples, medium 2001 may store a subset of the modules and data structures identified above. Furthermore, medium 2001 may store additional modules and data structures not described above.

Operating system 2022 can include various procedures, sets of instructions, software components and/or drivers for controlling and managing general system tasks (e.g., memory management, storage device control, power management, etc.) and facilitates communication between various hardware and software components.

Communication module 2024 can facilitate communication with other devices over one or more external ports 2036 or via RF circuitry 2008 and can include various software components for handling data received from RF circuitry 2008 and/or external port 2036.

Graphics module 2028 can include various known software components for rendering, animating and displaying graphical objects on a display surface. In examples in which touch I/O device 2012 is a touch sensing display (e.g., touch screen), graphics module 2028 can include components for rendering, displaying, and animating objects on the touch sensing display.

One or more applications 2030 can include any applications installed on system 2000, including without limitation, a browser, address book, contact list, email, instant messaging, word processing, keyboard emulation, widgets, JAVA-enabled applications, encryption, digital rights management, voice recognition, voice replication, location determination capability (such as that provided by the global positioning system (GPS)), a music player, etc.

Touch processing module 2026 can include various software components for performing various tasks associated with touch I/O device 2012 including but not limited to receiving and processing touch input received from I/O device 2012 via touch I/O device controller 2032.

I/O subsystem 2006 can be coupled to touch I/O device 2012 and one or more other I/O devices 2014 for controlling or performing various functions. Touch I/O device 2012 can communicate with processing system 2004 via touch I/O device controller 2032, which can include various components for processing user touch input (e.g., scanning hardware). One or more other input controllers 2034 can receive/send electrical signals from/to other I/O devices 2014. Other I/O devices 2014 may include physical buttons, dials, slider switches, sticks, keyboards, touch pads, additional display screens, or any combination thereof.

If embodied as a touch screen, touch I/O device 2012 can display visual output to the user in a GUI. The visual output may include text, graphics, video, and any combination thereof. Some or all of the visual output may correspond to user-interface objects. Touch I/O device 2012 can form a touch sensing surface that accepts touch input from the user. Touch I/O device 2012 and touch screen controller 2032 (along with any associated modules and/or sets of instructions in medium 2001) can detect and track touches or near touches (and any movement or release of the touch) on touch I/O device 2012 and can convert the detected touch input into interaction with graphical objects, such as one or more user-interface objects. In the case in which device 2012 is embodied as a touch screen, the user can directly interact with graphical objects that are displayed on the touch screen. Alternatively, in the case in which device 2012 is embodied as a touch device other than a touch screen (e.g., a touch pad), the user may indirectly interact with graphical objects that are displayed on a separate display screen embodied as I/O device 2014.

Touch I/O device 2012 may be analogous to the multi-touch sensing surface described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference.

In examples for which touch I/O device 2012 is a touch screen, the touch screen may use LCD (liquid crystal display) technology, LPD (light emitting polymer display) technology, OLED (organic LED), or OEL (organic electro luminescence), although other display technologies may be used in other examples.

Feedback may be provided by touch I/O device 2012 based on the user's touch input as well as a state or states of what is being displayed and/or of the computing system. Feedback may be transmitted optically (e.g., light signal or displayed image), mechanically (e.g., haptic feedback, touch feedback, force feedback, or the like), electrically (e.g., electrical stimulation), olfactorily, acoustically (e.g., beep or the like), or the like or any combination thereof and in a variable or non-variable manner.

System 2000 can also include power system 2044 for powering the various hardware components and may include a power management system, one or more power sources, a recharging system, a power failure detection circuit, a power converter or inverter, a power status indicator and any other components typically associated with the generation, management and distribution of power in portable devices.

Examples of the disclosure can be advantageous in enhancing a user's experience viewing one or more items in a user interface, such as an electronic storefront.

Therefore, according to the above, some examples of the disclosure are directed to a method comprising receiving an input for manipulating a first image in a user interface, manipulating the first image in accordance with the input, and manipulating a second image, different from the first image, in accordance with the input. Additionally or alternatively to one or more of the examples disclosed above, in some examples, the first image and the second image are concurrently displayed in the user interface. Additionally or alternatively to one or more of the examples disclosed above, in some examples, manipulating the first image comprises replacing the first image with a third image associated with the first image, and manipulating the second image comprises replacing the second image with a fourth image associated with the second image. Additionally or alternatively to one or more of the examples disclosed above, in some examples, a content of the first image corresponds to a content of the second image, and a content of the third image corresponds to a content of the fourth image. Additionally or alternatively to one or more of the examples disclosed above, in some examples, the first image is associated with a first category and the second image is associated with a second category, and the method further comprises determining that the first category is the same as the second category, wherein manipulating the second image comprises manipulating the second image in response to the determination. Additionally or alternatively to one or more of the examples disclosed above, in some examples, the first image is associated with a first set of images and the second image is associated with a second set of images, and the method further comprises determining that a number of images in the first set is the same as a number of images in the second set, wherein manipulating the second image comprises manipulating the second image in response to the determination. Additionally or alternatively to one or more of the examples disclosed above, in some examples, the user interface comprises a user interface of a store, the first image comprises an image of a first product in the store, and the second image comprises an image of a second product in the store. Additionally or alternatively to one or more of the examples disclosed above, in some examples, the first image presents a first view of the first product, the second image presents a first view of the second product, manipulating the first image comprises manipulating the first image to present a second view of the first product, and manipulating the second image comprises manipulating the second image to present a second view of the second product, the second view of the second product corresponding to the second view of the first product. Additionally or alternatively to one or more of the examples disclosed above, in some examples, the user interface includes a plurality of images, the plurality of images including the first image and the second image, and the method further comprises determining that each of the plurality of images is associated with a first category, wherein manipulating the second image comprises manipulating the second image in response to the determination. Additionally or alternatively to one or more of the examples disclosed above, in some examples, the input comprises an input to manipulate only the first image.

Some examples of the disclosure are directed to a method comprising presenting a first image of a first product in a user interface of a store, the store having a plurality of products including the first product and a second product, the first image providing a first view of the first product and a second image providing a first view of the second product, receiving an input for manipulating the first image to present a second view of the first product, different from the first view of the first product, manipulating the first image in accordance with the input, and manipulating the second image in accordance with the input to present a second view of the second product, different from the first view of the second product.

Some examples of the disclosure are directed to a non-transitory computer-readable storage medium having stored therein instructions, which when executed by a device, cause the device to perform a method comprising receiving an input for manipulating a first image in a user interface, manipulating the first image in accordance with the input, and manipulating a second image, different from the first image, in accordance with the input. Additionally or alternatively to one or more of the examples disclosed above, in some examples, the first image and the second image are concurrently displayed in the user interface. Additionally or alternatively to one or more of the examples disclosed above, in some examples, manipulating the first image comprises replacing the first image with a third image associated with the first image, and manipulating the second image comprises replacing the second image with a fourth image associated with the second image. Additionally or alternatively to one or more of the examples disclosed above, in some examples, a content of the first image corresponds to a content of the second image, and a content of the third image corresponds to a content of the fourth image. Additionally or alternatively to one or more of the examples disclosed above, in some examples, the first image is associated with a first category and the second image is associated with a second category, and the method further comprises determining that the first category is the same as the second category, wherein manipulating the second image comprises manipulating the second image in response to the determination. Additionally or alternatively to one or more of the examples disclosed above, in some examples, the first image is associated with a first set of images and the second image is associated with a second set of images, and the method further comprises determining that a number of images in the first set is the same as a number of images in the second set, wherein manipulating the second image comprises manipulating the second image in response to the determination. Additionally or alternatively to one or more of the examples disclosed above, in some examples, the user interface comprises a user interface of a store, the first image comprises an image of a first product in the store, and the second image comprises an image of a second product in the store. Additionally or alternatively to one or more of the examples disclosed above, in some examples, the first image presents a first view of the first product, the second image presents a first view of the second product, manipulating the first image comprises manipulating the first image to present a second view of the first product, and manipulating the second image comprises manipulating the second image to present a second view of the second product, the second view of the second product corresponding to the second view of the first product. Additionally or alternatively to one or more of the examples disclosed above, in some examples, the user interface includes a plurality of images, the plurality of images including the first image and the second image, and the method further comprises determining that each of the plurality of images is associated with a first category, wherein manipulating the second image comprises manipulating the second image in response to the determination. Additionally or alternatively to one or more of the examples disclosed above, in some examples, the input comprises an input to manipulate only the first image.

Some examples of the disclosure are directed to a non-transitory computer-readable storage medium having stored therein instructions, which when executed by a device, cause the device to perform a method comprising presenting a first image of a first product in a user interface of a store, the store having a plurality of products including the first product and a second product, the first image providing a first view of the first product and a second image providing a first view of the second product, receiving an input for manipulating the first image to present a second view of the first product, different from the first view of the first product, manipulating the first image in accordance with the input, and manipulating the second image in accordance with the input to present a second view of the second product, different from the first view of the second product. Additionally or alternatively to one or more of the examples disclosed above, in some examples, an apparatus comprises the computer-readable storage medium and a processor for executing the instructions.

Some examples of the disclosure are directed to an apparatus comprising a processor to execute instructions, and a memory coupled with the processor to store instructions, which when executed by the processor, cause the processor to perform a method comprising receiving an input for manipulating a first image in a user interface, manipulating the first image in accordance with the input, and manipulating a second image, different from the first image, in accordance with the input.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A method comprising:
receiving an input for manipulating a first image in a user interface;
manipulating the first image in accordance with the input; and
manipulating a second image, different from the first image, in accordance with the input.

2. The method of claim 1, wherein the first image and the second image are concurrently displayed in the user interface.

3. The method of claim 1, wherein:
manipulating the first image comprises replacing the first image with a third image associated with the first image, and
manipulating the second image comprises replacing the second image with a fourth image associated with the second image.

4. The method of claim 3, wherein a content of the first image corresponds to a content of the second image, and a content of the third image corresponds to a content of the fourth image.

5. The method of claim 1, wherein the first image is associated with a first category and the second image is associated with a second category, the method further comprising:
determining that the first category is the same as the second category,
wherein manipulating the second image comprises manipulating the second image in response to the determination.

6. The method of claim 1, wherein the first image is associated with a first set of images and the second image is associated with a second set of images, the method further comprising:
determining that a number of images in the first set is the same as a number of images in the second set,
wherein manipulating the second image comprises manipulating the second image in response to the determination.

7. The method of claim 1, wherein:
the user interface comprises a user interface of a store,
the first image comprises an image of a first product in the store,
and the second image comprises an image of a second product in the store.

8. The method of claim 7, wherein:
the first image presents a first view of the first product,
the second image presents a first view of the second product,
manipulating the first image comprises manipulating the first image to present a second view of the first product, and
manipulating the second image comprises manipulating the second image to present a second view of the second product, the second view of the second product corresponding to the second view of the first product.

9. The method of claim 1, wherein the user interface includes a plurality of images, the plurality of images including the first image and the second image, the method further comprising:
determining that each of the plurality of images is associated with a first category,
wherein manipulating the second image comprises manipulating the second image in response to the determination.

10. The method of claim 1, wherein the input comprises an input to manipulate only the first image.

11. A method comprising:
presenting a first image of a first product in a user interface of a store, the store having a plurality of products including the first product and a second product, the first image providing a first view of the first product and a second image providing a first view of the second product;
receiving an input for manipulating the first image to present a second view of the first product, different from the first view of the first product;
manipulating the first image in accordance with the input; and
manipulating the second image in accordance with the input to present a second view of the second product, different from the first view of the second product.

12. A non-transitory computer-readable storage medium having stored therein instructions, which when executed by a device, cause the device to perform a method comprising:
receiving an input for manipulating a first image in a user interface;
manipulating the first image in accordance with the input; and
manipulating a second image, different from the first image, in accordance with the input.

13. The computer-readable storage medium of claim 12, wherein the first image and the second image are concurrently displayed in the user interface.

14. The computer-readable storage medium of claim 12, wherein:
manipulating the first image comprises replacing the first image with a third image associated with the first image, and
manipulating the second image comprises replacing the second image with a fourth image associated with the second image.

15. The computer-readable storage medium of claim 14, wherein a content of the first image corresponds to a content of the second image, and a content of the third image corresponds to a content of the fourth image.

16. The computer-readable storage medium of claim 12, wherein the first image is associated with a first category and the second image is associated with a second category, the method further comprising:
determining that the first category is the same as the second category,
wherein manipulating the second image comprises manipulating the second image in response to the determination.

17. The computer-readable storage medium of claim 12, wherein the first image is associated with a first set of images and the second image is associated with a second set of images, the method further comprising:
determining that a number of images in the first set is the same as a number of images in the second set,
wherein manipulating the second image comprises manipulating the second image in response to the determination.

18. The computer-readable storage medium of claim 12, wherein:
the user interface comprises a user interface of a store,
the first image comprises an image of a first product in the store,
and the second image comprises an image of a second product in the store.

19. The computer-readable storage medium of claim 18, wherein:
the first image presents a first view of the first product,
the second image presents a first view of the second product,
manipulating the first image comprises manipulating the first image to present a second view of the first product, and
manipulating the second image comprises manipulating the second image to present a second view of the second product, the second view of the second product corresponding to the second view of the first product.

20. The computer-readable storage medium of claim 12, wherein the user interface includes a plurality of images, the plurality of images including the first image and the second image, the method further comprising:
determining that each of the plurality of images is associated with a first category,
wherein manipulating the second image comprises manipulating the second image in response to the determination.

21. The computer-readable storage medium of claim 12, wherein the input comprises an input to manipulate only the first image.

22. A non-transitory computer-readable storage medium having stored therein instructions, which when executed by a device, cause the device to perform a method comprising:
presenting a first image of a first product in a user interface of a store, the store having a plurality of products including the first product and a second product, the first image providing a first view of the first product and a second image providing a first view of the second product;
receiving an input for manipulating the first image to present a second view of the first product, different from the first view of the first product;
manipulating the first image in accordance with the input; and
manipulating the second image in accordance with the input to present a second view of the second product, different from the first view of the second product.

23. An apparatus comprising the computer-readable storage medium of claim 22, the apparatus further comprising a processor for executing the instructions.

24. An apparatus comprising:
a processor to execute instructions; and
a memory coupled with the processor to store instructions, which when executed by the processor, cause the processor to perform a method comprising:
receiving an input for manipulating a first image in a user interface;
manipulating the first image in accordance with the input; and
manipulating a second image, different from the first image, in accordance with the input.
